(19) United States
(12) Patent Application Publication
(10) Pub. No.: US 2010/0063999 A1
(43) Pub. Date: Mar. 11, 2010

(54) SOFTWARE ON-DEMAND SERVICE INTERLOCKING SYSTEM AND METHOD OF OPERATING THE SAME

(75) Inventors: Sung Jin Hur, Daejeon (KR); Jeong Min Shim, Daejeon (KR); Kyong I Ku, Gyunggi-do (KR); Sung Joo Kang, Seoul (KR); Wan Choi, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 12/517,346

(22) PCT Filed: Dec. 4, 2007
(86) PCT No.: PCT/KR2007/006238

§ 371 Date: Jun. 2, 2009

(30) Foreign Application Priority Data
Dec. 4, 2006 (KR) 10-2006-0121622
Jul. 16, 2007 (KR) 10-2007-0071106

(51) Int. Cl. G06F 15/16

(52) U.S. Cl. 709/203; 709/231

(57) ABSTRACT

There are provided a software on-demand service interlocking system and a method of operating the system. To provide a software service by selecting one of various software service methods considering a software service environment varying with a service providing point in time, the system includes a service providing apparatus providing requested software to a client terminal in one of the various software service providing methods in response to a software execution request of the client terminal and a service relaying apparatus selecting a software service method suitable for a software service environment at a requesting point in time, in response to a relay request of the client terminal, and relaying the selected software service method to the client terminal. Therefore, the software may be provided by selecting a software service method suitable for a software service environment at a service providing point in time, thereby more quickly and stably providing the software to a user.

### TECHNICAL FIELD

The present invention relates to a software on-demand service interlocking system, and more particularly, to a software on-demand service interlocking system and a method of operating the system, in which a software service is provided by selecting one of various kinds of software service methods considering a software service environment varying with a service providing point in time.

The work was supported by the IT R&D program of MIC/IITA [2005-S-007-02, Public Software-Based On-Demand Office Environment Providing Technology Development].

### BACKGROUND ART

Presently, a software on-demand service methods generally used are divided into a software streaming method, a terminal method, and a download-based software virtualization method, depending on a detailed method of executing software.

In the case of the software streaming method, a client terminal receives only a streamed execution code of software from a server, without installing the software. In the case of the terminal method, a server directly executes software and provides only a result of the execution to a client terminal. In the case of the download-based software virtualization method, a client terminal downloads software from a server, generates a virtual execution environment, and executes the software as if the software is installed in a system thereof.

Software service methods like these employ mutually different transmission technology and control technology between a server and a client terminal, respectively, thereby independently being employed and developed toward mutually different fields. Therefore, conventional software service methods have computing power information of a client terminal and mutually different communication network environment between the client terminal and a server, depending on a kind thereof.

However, due to operating characteristics of general network communication systems and client terminals, generally, the computing power information of the client terminal, the communication network environment between the server and users, and a software service environment are not fixed and frequently change.

Accordingly, it is capable of being known that a software service method suitable for the software service environment is also not fixed and frequently changes.

### DISCLOSURE OF INVENTION

### Technical Problem

However, since the conventional software service methods are independently embodied in mutually different service areas as described above, it is impossible to select a software service method by considering a software service environment varying with a service providing point in time.

### Technical Solution

According to an aspect of the present invention, there is provided a software on-demand service interlocking system comprising: a service providing apparatus capable of providing software in various software service methods and providing requested software to a client terminal in one of the various software service providing methods in response to a software execution request of the client terminal; and a service relaying apparatus selecting a software service method suitable for a software service environment at a requesting point in time, in response to a relay request of the client terminal, and relaying the selected software service method to the client terminal.

According to another aspect of the present invention, there is provided a service relaying apparatus comprising: a server registration unit registering a service providing apparatus in response to a registration request of the service providing apparatus; a server registration information storage unit storing access information and software information of the registered service providing apparatus; and a relay control unit selecting a software service method suitable for a software service environment at a requesting point in time from various software service methods and relaying the selected software service method to a client terminal when the client terminal requests an execution of software.

According to still another aspect of the present invention, there is provided a method of operating a software on-demand service interlocking system, the method comprising: registering a service providing apparatus and storing access information and software information of the service providing apparatus by a service relaying apparatus in response to a registration request of the service providing apparatus; selecting and notifying a software service method suitable for a software service environment at a requesting point in time to a client terminal by the service relaying apparatus in response to a relay request of the client terminal; and providing software in the selected software service method by the service providing apparatus in response to a software execution request of the client terminal.

According to yet another aspect of the present invention, there is provided a method of relaying a software on-demand service in a service relaying apparatus, the method comprising: registering a software providing apparatus and storing access information and software information of the service providing apparatus when a registration request is received from the service providing apparatus; and selecting and relaying a software service method suitable for a software service environment at a requesting point in time to a client terminal when a relay request is received from the client terminal.

### Advantageous Effects

As described above, the software on-demand service interlocking system and a method of operating the system according to an exemplary embodiment of the present invention may provide software in all kinds of various software service methods and may select one software service method by considering a software service environment varying with a service providing point in time. Therefore, a service method suitable for a software service environment at a service providing point in time may be selected by considering the software service environment frequently changing, thereby quickly and stably providing a service for software requested by a user.

### BRIEF DESCRIPTION OF THE DRAWINGS

FIG. 1 is a flowchart illustrating a software streaming method;

FIG. 2 is a flowchart illustrating a terminal method;

FIG. 3 is a flowchart illustrating a download-based software virtualization method;

FIG. 4 is a block diagram illustrating a software on-demand service interlocking system according to an exemplary embodiment of the present invention;

FIG. 5 is a detailed configuration diagram illustrating the software on-demand service interlocking system of FIG. 4;

FIG. 6 is a flowchart illustrating a method of operating the software on-demand service interlocking system according to an exemplary embodiment of the present invention; and

FIG. 7 is a flowchart illustrating service relaying operations of a service repeater according to an exemplary embodiment of the present invention.

### BEST MODE FOR CARRYING OUT THE INVENTION

Hereinafter, exemplary embodiments of the present invention will now be described in detail with reference to the accompanying drawings. Only, in describing operations of the exemplary embodiments in detail, when it is considered that a detailed description on related well-known functions or constitutions unnecessarily may make essential points of the present invention be unclear, the detailed description will be omitted.

In the drawings, the same reference numerals are used throughout to designate the same or similar components.

Before describing the embodiments, to help understanding the present invention, a conventional software streaming method, a conventional terminal method, and a conventional download-based software virtualization method will be described, respectively.

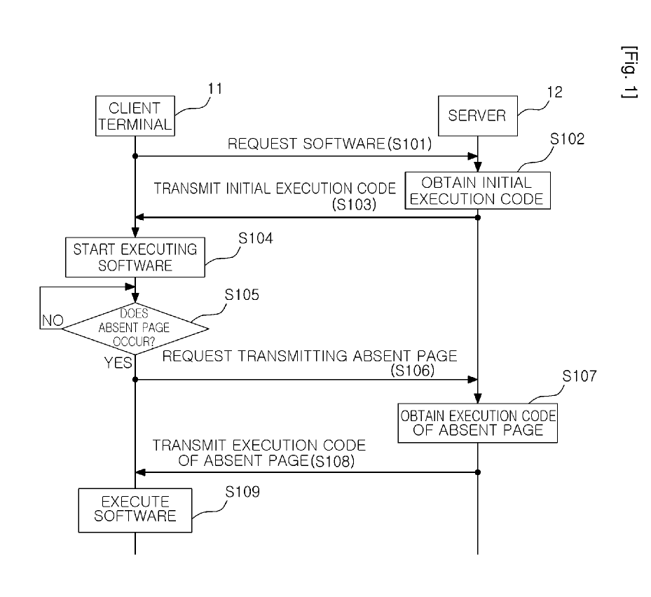

FIG. 1 is a flowchart illustrating the software streaming method.

Referring to FIG. 1, when a user wants to execute certain software, a client terminal 11 accesses a server 12 and requests an execution of the software (S101). The server 12 obtains only an initial execution code required for an initial execution from an execution code stored in a storage device thereof (S102) and streams the initial execution code to the client terminal 11 (S103).

Then, the client terminal 11 starts executing the software based on the initial execution code (S104). When requiring a page that is not streamed (S105), the server 12 is requested to transmit an execution code for the page (S106).

In response to this, the server 12 obtains only the execution code for the page (S107) and streams the execution code to the client terminal 11 (S108). The client terminal 11 executes the software based on the streamed execution code, as if the software is present in a local system thereof (S109).

As described above, in the case of the software streaming method, an execution code of software present in a server is streamed as much as required and a client terminal executes the software by using computing power information thereof.

Accordingly, since it is required to transfer a large amount of data between the server and the client terminal in the beginning of the streaming, the software streaming method is suitable for a case where a communication network environment between the server and the client terminal is relatively good and there is enough computing power in the client terminal.

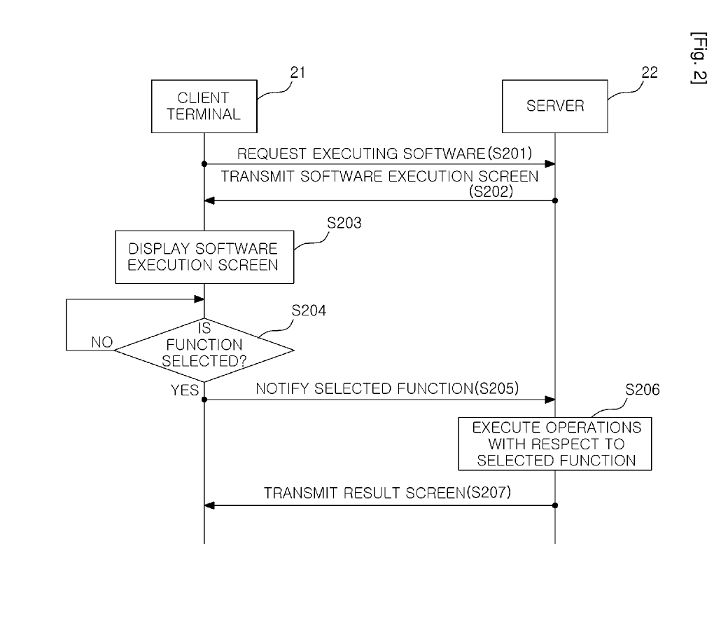

FIG. 2 is a flowchart illustrating the terminal method.

Referring to FIG. 2, when a user wants to execute certain software, a client terminal 21 accesses a server 22 and requests an execution of the software (S201). The server 22 directly executes the software and transmits an execution screen of the software (S202).

The client terminal 21 displays the received execution screen as if the client terminal 21 directly executes the software (S203) to allow the user to select a certain function on the execution screen (S204).

Then, when the user selects the certain function, the client terminal 21 notifies the function to the server 22 (S205) and, in response to this, the server 22 executes operations corresponding to the selected function (S206) and transmits only an execution result screen to the client terminal 21 (S207).

As described above, in the case of the terminal method, a client terminal does not additionally install software and a server directly executes software requested by the client terminal and transmits only an execution screen of the software or an execution result screen.

Accordingly, the terminal method is suitable for a case where there is no load to transfer a lot of data, a communication network environment between a server and a client terminal is bad, and computing power of the client terminal is weak.

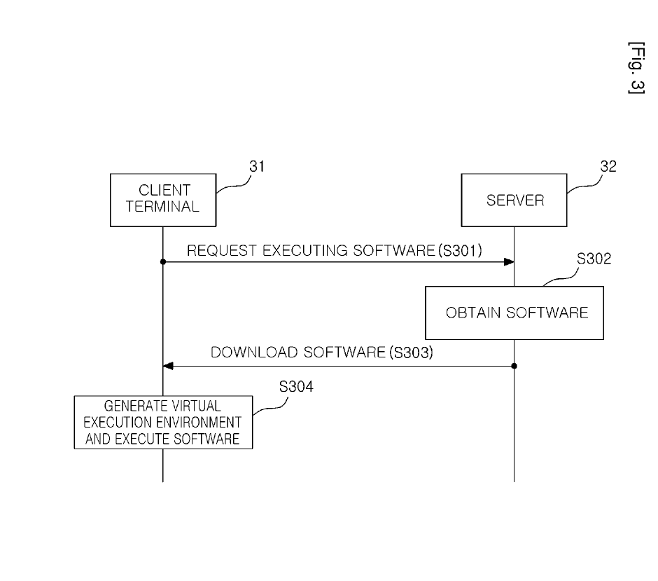

FIG. 3 is a flowchart illustrating the download-based software virtualization method.

Referring to FIG. 3, when a user wants to execute certain software, a client terminal 31 accesses a server 32 and requests an execution of the software (S301). The server 32 obtains the corresponding software (S302) and downloads the obtained software to the client terminal 31 (S303).

The client terminal 31 generates a virtual execution environment for the downloaded software and executes the software as if the software is installed in a system thereof (S304).

As described above, since a client terminal interchanges a control message with a server, downloads software from the server, and executes the software using a software virtualization method, the download-based software virtualization method is suitable for software that requires no additional condition with respect to a communication network environment between the server and client terminal but requires stable operating characteristics to be capable of being executed in an offline state.

As described above, it may be known that the respective software service methods require mutually different software service environments depending on a method of executing software.

Accordingly, according to the present invention, an additional service repeater is present to select one software service method by considering a software service environment varying with a service providing point in time and to relay software to a client terminal via the software service method in such a way that the client terminal receives the software in a method most suitable for the software service environment.

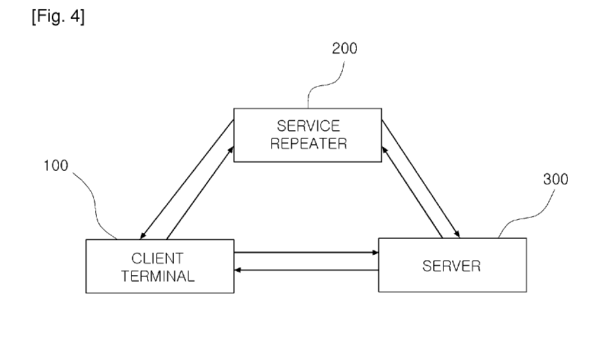

FIG. 4 is a block diagram illustrating a software on-demand service interlocking system according to an exemplary embodiment of the present invention.

Referring to FIG. 4, the software on-demand service interlocking system includes a client terminal 100, a service repeater 200, and a server 300.

When a user requests an execution of software, the client terminal 100 is relayed a server and service method suitable for a present software service environment via the service repeater 200. The client terminal 100 accesses the server 300 that is relayed, is provided the software requested by the user, and services the software to the user in the relayed software service method.

In this case, the client terminal 100 provides software information and computing power information of the client terminal 100 to the service repeater 200 when requesting service relay to allow the service repeater 200 to accurately recognize the actually requested software and an operating state of the client terminal 100.

Here, the software information relates to identification information and operating characteristics of the actually requested software and the computing power information includes options, a load amount, and a communication speed of a client terminal to allow operating performance of the client terminal to be estimated.

The service repeater 200 registers the server 300 and stores registration information of the registered server 300. When the client terminal 100 requests service relay with respect to certain software, the service repeater 200 checks a server providing the software by referring to the stored registration information, selects a software service method most suitable for a software service environment at a service providing point in time by considering one or more of a communication network environment between the client terminal 100 and the server 300, the computing power information of the client terminal 100, and the operating characteristics of the software, and notifies the client terminal 100 of the most suitable software service method.

In this case, the registration information of the server 300 includes access information of the server 300 and information of the software provided to the server 300.

The server 300 registers itself in the service repeater 200 by transmitting the registration information thereof to the service repeater 200. When the client terminal 100 accesses and requests the software to be provided in the service method relayed by the service repeater 200, the server 300 provides the requested software in the relayed service method.

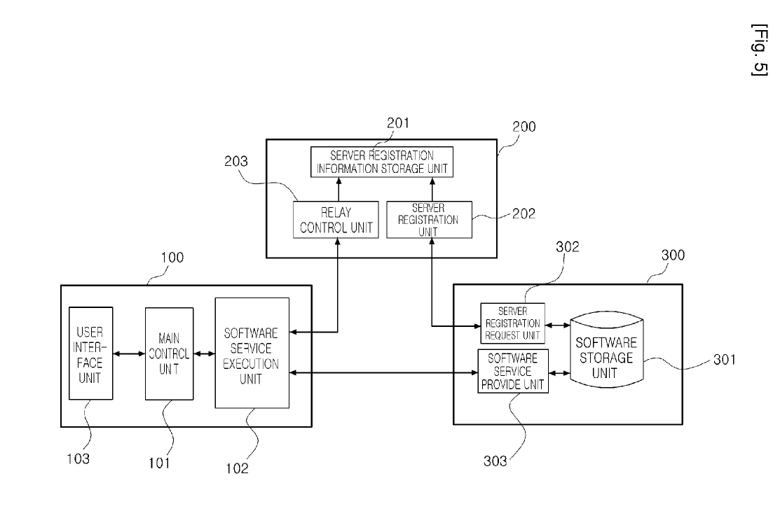

FIG. 5 is a detailed configuration of the software on-demand service interlocking system of FIG. 4.

Referring to FIG. 5, the client terminal 100 includes a main control unit 101, a software service execution unit 102, and a user interface unit 103. The service repeater 200 includes a server registration information storage unit 201, a server registration unit 202, and a relay control unit 203. The server 300 includes a software storage unit 301, a server registration request unit 302, and a software service providing unit 303.

Hereinafter, each of the elements will be described as follows.

The main control unit 101 of the client terminal 100 analyzes an input operation of a user inputted via the user interface unit 103 and controls overall operations of the client terminal 100 according to a result of the analyzing. Particularly, when the user requests an execution of software provided via the software on-demand service method, the main control unit 101 senses a requesting operation of user and notifies the software service execution unit 102.

When the user requests an execution of software, the software service execution unit 102 transmits information of the software and computing power information of the client terminal 100 to the service repeater 200 and requests service relay. In response to this, the service repeater 200 relays a server and a service method, the software service execution unit 102 access the server 300 that is relayed, and requests that the software requested by the user is provided in the relayed service method.

The user interface unit 103 is embodied as various input devices such as a keyboard and a mouse, which senses various input operations of the user and notifies the main control unit 101.

The server registration information storage unit 201 of the service repeater 200 stores registration information of the server 300 registered via the server registration unit 202.

When the server transmits the registration information and requests a registration, the server registration unit 202 registers the server 300 and stores the transmitted registration information in the server registration information storage unit 201.

When the client terminal 100 accesses and requests service relay, the relay control unit 203 selects the server 300 providing the software requested by the client terminal 100 by referring to the registration information stored in the server registration information storage unit 201 and relays access information of the selected server 300 to the client terminal 100. Simultaneously, the relay control unit 203 monitors a communication network state between the selected server 300 and the client terminal 100 and selects and relays a service method suitable for a present software service environment by considering one or more of a result of the monitoring, the computing power information of the client terminal 100, and the operating characteristics of the software, to the client terminal 100.

In this case, when there is a plurality of servers registered in the service repeater 200 and there is also a plurality of servers providing the software requested by the client terminal 100, the relay control unit 203 selects a server whose communication network state with the client terminal 100 is best.

The software storage unit 301 of the server 300 stores software to be provided to the client terminal 100 by the server 300.

When the service repeater 200 is first accessed or an operator of server requests a registration of a server, the server registration request unit 302 generates registration information including access information of the server 300 and software information and transmits the registration information to the service repeater 200 to request a registration.

The software service providing unit 303 may provide the software stored in the software storage unit 301 in all of the software streaming method, the terminal method, and the download-based software virtualization method. The software service providing unit 303 selects one method according to a request of the client terminal 100. When the client terminal 100 accesses and requests the software stored in the software storage unit 301 to be provided in the service method relayed by the service repeater 200, the software service providing unit 303 searches the software storage unit 301, obtains the software, and provides the software in the requested service method.

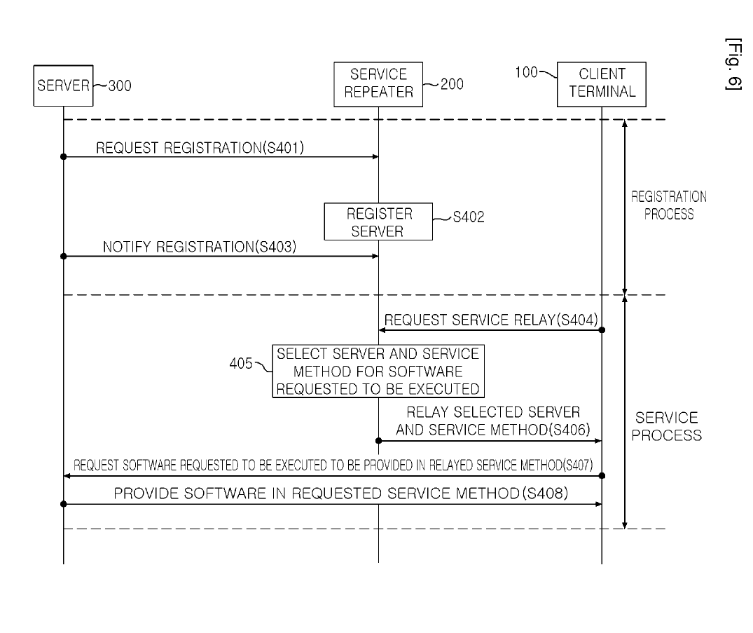

FIG. 6 is a flowchart illustrating a method of operating the software on-demand service interlocking system according to an exemplary embodiment of the present invention.

Referring to FIG. 6, the server 300 generates and transmits a registration request message including access information of its own and software information to the service repeater 200 to register the server itself in the service repeater 200 (S401).

The service repeater 200 receives and analyzes the registration request message transmitted from the server 300, registers the server 300, and stores registration information stored in the registration request message (S402).

When S402 is successfully performed, the service repeater 200 notifies the server 300 to allow the server 300 to recognize whether the registration successes (S403).

In this case, when the client terminal 100 generates and transmits a software relay request message including information of software requested by a user to be executed and computing power information of its own (S404), the service repeater 200 analyzes the software relay request message and obtains the information of the software and the computing power information of the client terminal 100. The service repeater 200 selects a server to provide the software by referring to the registration information stored in S402, monitors a communication network state between the selected server 300 and the client terminal 100, and selects a software service method suitable for a present software service environment by considering one or more of a result of the monitoring, the computing power information of the client terminal 100, and operating characteristics of the software (S405).

The service repeater 200 notifies the access information of the server 300 and the service method selected in S405 to the client terminal 100 (S406), and the client terminal 100 accesses the server 300 relayed by the service repeater 200 by using the notified access information and requests the software requested by the user to be provided in the service method relayed by the service repeater 200 (S407).

Then, in response to the request of the client terminal 100, the server 300 searches and obtains the software and provides the software in the service method requested by the client terminal 100 (S408).

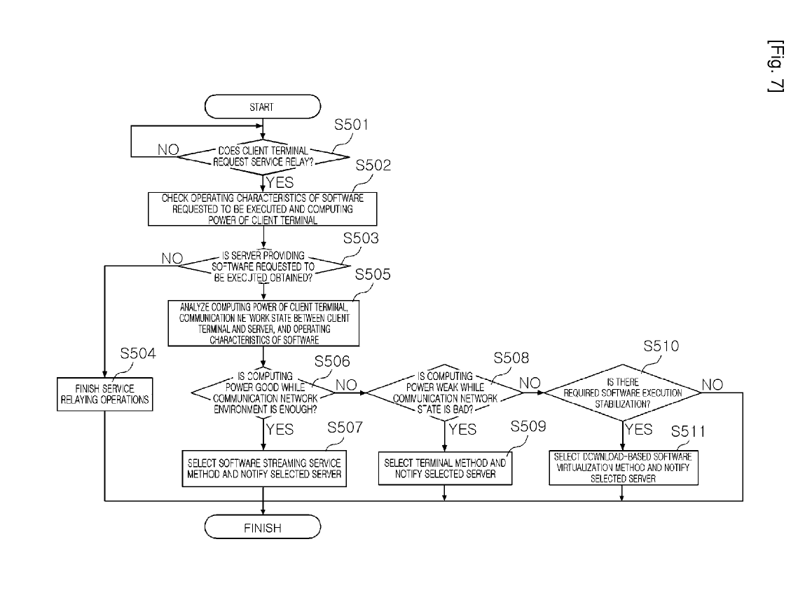

FIG. 7 is a flowchart illustrating service relaying operations of the service repeater 200 according to an exemplary embodiment of the present invention.

When the client terminal 100 requests service relay by transmitting a software relay request message (S501), the service repeater 200 analyzes the software relay request message and checks a kind and operating characteristics of software requested to be executed and computing power information of the client terminal 100 (S502).

It is checked whether there exists the server 300 capable of providing the software requested to be executed by referring to the registration information stored in S402 of FIG. 6 (S503). When there is no server capable of providing the software requested to be executed, the service repeater 200 notifies it to the client terminal 100 and finishes the service relaying operation (S504).

On the other hand, when there is a server 300 providing the software requested to be executed, the service repeater 200 select the server 300, a communication network state between the selected server 300 and the client terminal 100 is monitored, and a result of the monitoring, the operating characteristics of the software, the computing power information of the client terminal 100, checked in S502, are analyzed (S505).

As a result of the analyzing, when computing power of the client terminal 100 is enough while the communication network state between the selected server 300 and the client terminal 100 is relatively good (S506), the service repeater 200 selects the software streaming method and notifies the selected service method and server to the client terminal 100.

On the other hand, when the computing power of the client terminal 100 is weak and the communication network state between the selected server 300 and the client terminal 100 is bad (S508), the service repeater 200 selects the terminal method and notifies the selected service method and server to the client terminal 100 (S509).

Regardless of the computing power information of the client terminal 100 and the communication network state of the selected server 300 and the client terminal 100, when the software requested to be executed has operating characteristics to be stably performed (S510), the service repeater 200 selects the download-based software virtualization method and notifies the selected service method and server to the client terminal 100 (S511).

In the above description, though it is described and defined that the software on-demand service interlocking system includes one server and one server provides a piece of software, actually, it is natural that there is a lot of servers and each of the plurality of servers may provide one or more piece of software.

Also, terms of the server and the service repeater used in the description are concepts in a broad sense, which may be used as a service providing apparatus and a service relaying apparatus.

While the present invention has been shown and described in connection with the exemplary embodiments, it will be apparent to those skilled in the art that modifications and variations can be made without departing from the spirit and scope of the invention as defined by the appended claims.

1. A software on-demand service interlocking system comprising:
a service providing apparatus capable of providing software in various software service methods and providing requested software to a client terminal in one of the various software service providing methods in response to a software execution request of the client terminal; and
a service relaying apparatus selecting a software service method suitable for a software service environment at a requesting point in time, in response to a relay request of the client terminal, and relaying the selected software service method to the client terminal.

2. The system of claim 1, wherein the various software service methods comprises one or more of a software streaming method, a terminal method, and a download-based software virtualization method.

3. The system of claim 1, wherein the service relaying apparatus registers the service providing apparatus and stores access information and software information of the service providing apparatus.

4. The system of claim 3, wherein the service relaying apparatus comprises:
a server registration unit registering the service providing apparatus in response to a registration request of the service providing apparatus;
a server registration information storage unit storing the access information and software information of the registered service providing apparatus; and
a relay control unit selecting a software service method suitable for a software service environment at a requesting point in time and relaying the selected software service method to the client terminal when the client terminal requests an execution of software.

5. The system of claim 4, wherein the relay control unit selects the software service method by considering one or more of a condition of a communication network between the client terminal and the service providing apparatus, an operating condition of the client terminal, and operating characteristics of the software.

6. The system of claim 4, wherein the relay control unit selects and notifies the service providing apparatus providing the software requested to be executed, to the client terminal.

7. The system of claim 6, wherein the relay control unit selects a service providing apparatus having a good communication network state with the client terminal when there is registered a plurality of the service providing apparatus providing the software requested to be executed.

8. The system of claim 1, wherein the service providing apparatus comprises:
a software storage unit storing software to be provided to the client terminal;
a server registration request unit collecting and transmitting the access information and software information of the service providing apparatus to the service relaying apparatus and requesting a registration in the service relaying apparatus; and
a software service providing unit capable of software in various software service methods, the software service providing unit selecting software to be serviced and a software service method according to a request of the client terminal and providing the selected software to the client terminal in the selected software service method.

9. A service relaying apparatus comprising:
a server registration unit registering a service providing apparatus in response to a registration request of the service providing apparatus;
a server registration information storage unit storing access information and software information of the registered service providing apparatus; and
a relay control unit selecting a software service method suitable for a software service environment at a requesting point in time from various software service methods and relaying the selected software service method to a client terminal when the client terminal requests an execution of software.

10. The service relaying apparatus of claim 9, wherein the various software service methods comprises one or more of a software streaming method, a terminal method, and a download-based software virtualization method.

11. The service relaying apparatus of claim 9, wherein the relay control unit selects the software service method by considering one or more of a condition of a communication network between the client terminal and the service providing apparatus, an operating condition of the client terminal, and operating characteristics of the software.

12. The service relaying apparatus of claim 9, wherein the relay control unit selects and notifies the service providing apparatus providing the software requested to be executed, to the client terminal.

13. The service relaying apparatus of claim 12, wherein the relay control unit selects a service providing apparatus having a good communication network state with the client terminal when there is registered a plurality of the service providing apparatus providing the software requested to be executed.

14. A method of operating a software on-demand service interlocking system, the method comprising:
registering a service providing apparatus and storing access information and software information of the service providing apparatus by a service relaying apparatus in response to a registration request of the service providing apparatus;
selecting and notifying a software service method suitable for a software service environment at a requesting point in time to a client terminal by the service relaying apparatus in response to a relay request of the client terminal; and
providing software in the selected software service method by the service providing apparatus in response to a software execution request of the client terminal.

15. The method of claim 14, wherein the software service method is one of a
software streaming method, a terminal method, and a download-based software virtualization method.

16. The method of claim 14, wherein, in the selecting and notifying, the suitable
software service method is selected by considering one or more of a condition of a communication network between the client terminal and the service providing apparatus, an operating condition of the client terminal, and operating characteristics of the software.

17. The method of claim 16, wherein the selecting and notifying comprises:
selecting the software streaming method and relaying when computing power of the client terminal is enough and a state of a communication network between the selected service providing apparatus and the client terminal is relatively satisfactory;
selecting the terminal method and relaying when the computing power of the client terminal is weak and the state of the communication network between the service providing apparatus and the client terminal is poor; and
selecting the download-based software virtualization method and relaying when the software requested to be executed has operating properties of being stably executed.

18. The method of claim 17, wherein the selecting and notifying further comprises
selecting the service providing apparatus providing the software requested to be executed and relaying.

19. The method of claim 18, wherein, in the selecting the service providing apparatus, a service providing apparatus with a good communication network state with the client terminal is selected when there is registered a plurality of service providing apparatuses providing the software requested to be executed.

20. A method of relaying a software on-demand service in a service relaying apparatus, the method comprising:
registering a software providing apparatus and storing access information and software information of the service providing apparatus when a registration request is received from the service providing apparatus; and
selecting and relaying a software service method suitable for a software service environment at a requesting point in time to a client terminal when a relay request is received from the client terminal.

21. The method of claim 20, wherein the software service method is one of a
software streaming method, a terminal method, and a download-based software virtualization method.

22. The method of claim 21, wherein, in the selecting and relaying, the software service method is selected by considering one or more of a condition of a communication network between the client terminal and the service providing apparatus, an operating condition of the client terminal, and operating characteristics of the software.

23. The method of claim 22, wherein the selecting and relaying comprises:
selecting and relaying the software streaming method and relaying when computing power of the client terminal is enough and a state of a communication network between the selected service providing apparatus and the client terminal is relatively satisfactory;
selecting and relaying the terminal method and relaying when the computing power of the client terminal is weak and the state of the communication network between the selected server and the client terminal is poor; and
selecting and relaying the download-based software virtualization method and relaying when the software requested to be executed has operating properties of being stably executed.

24. The method of claim 23, wherein, in the selecting and relaying further comprises selecting and relaying the service providing apparatus providing the software requested to be executed.

25. The method of claim 24, wherein, in the selecting and relaying, a service providing apparatus with a good communication network state with the client terminal is selected when there is registered a plurality of service providing apparatuses providing the software requested to be executed.
